(19) United States
(12) Patent Application Publication
(10) Pub. No.: US 2006/0107027 A1
(43) Pub. Date: May 18, 2006

(54) General purpose micro-coded accelerator

(76) Inventors: Inching Chen, Portland, OR (US); Ernest T. Tsui, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/987,327

(22) Filed: Nov. 12, 2004

(51) Int. Cl. G06F 9/30

(52) U.S. Cl. 712/221; 712/218

(57) ABSTRACT

A micro-coded accelerator may comprise multiple programmable control units, multiple special function units, a cross-bar switch to connect any of the control units to any one or more of the special function units, and a global memory to facilitate processing by these units. Each control unit may have an array of programmable logic arrays (ARPLAs), each of which may be configured in various ways, a local memory, and a switch circuit to enable the components of the control unit to perform various operations. By configuring the ARPLAs, the control units' internal switch circuitry, and the cross-bar switch, the micro-coded accelerator may be dynamically reconfigured to perform multiple types of operations.

### BACKGROUND

The front end of a wireless device, such as a wireless LAN device or a cell phone, is required to perform repetitive high speed operations on received signals. Frequently these operations are performed by a digital signal processor (DSP), which is better suited for these operations than is a general purpose processor and can dynamically change its program to handle a variety of signal processing tasks. However, the general purpose nature of a DSP may make make it less efficient, both in terms of throughput and in terms of power consumption, than an application specific integrated circuit (ASIC) that has been designed specifically for a particular signal processing task. By contrast, the ASIC may be too inflexible for use in modem signal processing applications, especially those applications that require the device to handle multiple protocols and/or to be upgraded as the technology advances.

### BRIEF DESCRIPTION OF THE DRAWINGS

The invention may be understood by referring to the following description and accompanying drawings that are used to illustrate embodiments of the invention. In the drawings:

FIG. 1 shows a block diagram of a general purpose micro-coded accelerator (GPMCA), according to an embodiment of the invention.

FIG. 2 shows a block diagram of a control unit, according to an embodiment of the invention.

FIG. 3 shows a block diagram of a basic cell, according to an embodiment of the invention.

FIGS. 4A, 4B show block diagrams of programmable logic arrays (PLAs) containing basic cells, according to some embodiments of the invention.

FIG. 5 shows a block diagram of an array of programmable logic arrays, according to an embodiment of the invention.

FIG. 6 shows a block diagram of a special function unit (SU) to perform calculations, according to an embodiment of the invention.

FIG. 7 shows a flow diagram of a method of configuring and operating a GPMCA, according to an embodiment of the invention.

FIG. 8 shows a block diagram of a system, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

The term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

The invention may be implemented in one or a combination of hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

Various embodiments of the invention may pertain to a device (or method of operating the device), whose operation can be reprogrammed and reconfigured dynamically to perform various types of high speed data manipulations. In some embodiments the data manipulations may pertain to signal processing. The device may contain some characteristics of a fixed-design ASIC and some characteristics of a programmable processor.

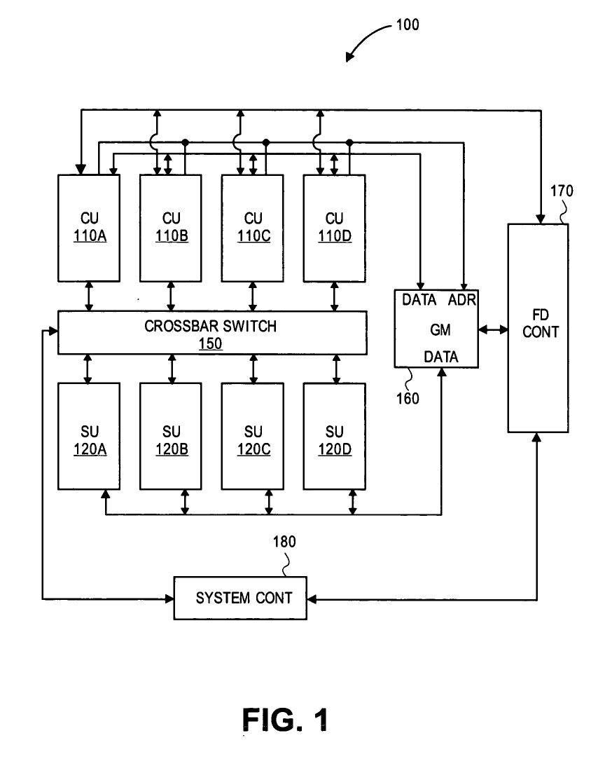

FIG. 1 shows a block diagram of a general purpose micro-coded accelerator (GPMCA), according to an embodiment of the invention. As a matter of convenience, the term GPMCA may be used throughout this disclosure; however, that label should not be used to artificially read limitations into embodiments of the invention. In the illustrated embodiment, GPMCA 100 may comprise multiple control units (CU) 110, multiple special function units (SU) 120, a crossbar switch 150, a global memory (GM) 160, a function dispatcher and data (FD) controller 170, and a system controller 180.

Each CU 110 may operate as a processing element independent of any SU 120, or may alternately work as a control element by cooperatively operating with one or more SU's 120 and directing data in and out of the associated SU's 120. In some embodiments one or more SU's 120 may be placed in a low-power mode if not being controlled by a CU 110. The illustrated embodiment shows four CU's 110, labeled A-D, and four SU's 120, also labeled A-D, although other embodiments may have other quantities of CU's and/or SU's. Crossbar switch 150 may be configured to let a selected CU work with a selected SU, and/or to let a selected CU work with selected multiple SU's. For example, in one particular configuration CU 110A may be the control element for SU's 120 A-B, CU 110B may be the control element for SU 120C, CU 110C may be the control element for SU 120D, and CU110D may not be coupled to any SU. In another configuration, CU 110C may be the control element for SU's 120 A-D, while CU's 110A, B, D might not control any SU's. Other configurations are also possible. A single CU 110 operating as a control element for multiple SU's 120 may operate on data that is too wide for a single SU 120, while multiple CU's 110 acting as control elements for different SU's 120 may perform simultaneous operations on different and/or the same data.

GM 160 may serve as both a source and a destination for data operated upon by the SU's, and may serve as both a source and a destination for data operated upon by the CU's. The CU's may also provide addressing information to the GM 160 for data transfers into and/or out of GM 160. The address connection between the CU's and the GM 160 may be implemented in any feasible manner. FD 170 may operate as a controller to set up the CU's before an operation, and may also transfer data into and/or out of the GM 160. System controller 180 may operate as an overall controller for GPMCA 100. In some embodiments system controller 180 may configure crossbar switch 150 to link selected CU's with selected SU's, although in other embodiments this configuration control may be provided by FD controller 170 or some other circuit.

In some operations, the cross-bar switches may be configured, data may be placed in the GM, the CU's may be programmed to control specific operations in the SU's, and then the CU's may be started, with the resulting operations to run autonomously until complete. Operations may then be repeated with a different configuration and/or data set, thus permitting the same circuit to dynamically change its operations.

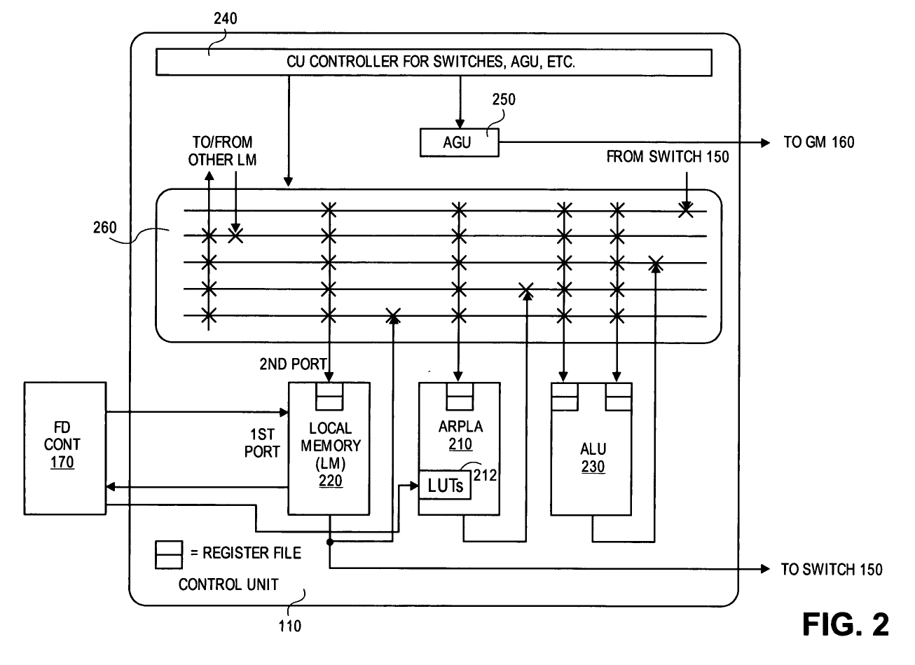

FIG. 2 shows a block diagram of a control unit, according to an embodiment of the invention. In the illustrated embodiment, CU 110 may comprise an array of programmable logic arrays (ARPLA) 210, a local memory (LM) 220, an arithmetic logic unit (ALU) 230, a CU controller 240, an address generation unit (AGU) 250, and a crossbar switch 260 (which is a different element than the crossbar switch 150 shown in FIG. 1). Crossbar switch 260 may be configured to connect the ARPLA 210, LM 220, ALU 230, and in some embodiments LMs from other CUs, together as needed to permit data transfer between these devices. In the illustrated embodiment, both inputs and outputs of ARPLA 210, LM 220, and ALU 230 may be routed by the crossbar switch 260. The crossbar switch may be used to selectively connect the various vertical paths shown to the various horizontal paths shown by making or breaking electrical connections at the points in the matrix indicated with an ‘X’. Each path shown with a single vertical and/or horizontal line may represent multiple signal lines (such as 32 signal lines, although the embodiments of the invention may not be limited in this manner) that are connected or disconnected at the same time. For example, the illustrated crossbar switch 260 might connect 32 output signals of LM 220 to the first (lowest) horizontal path in crossbar switch 260, which may then be connected to the vertical paths representing the inputs of the LM 220, the ARPLA 210, and/or the ALU 230, as well as to inputs of other LMs through the leftmost vertical path shown. (Note: directional terms like vertical, horizontal, lowest, highest, leftmost, rightmost, etc. are to be interpreted herein with respect to their orientation in the drawings, not with the orientation of actual devices in the real world). The output signals of ARPLA 210 may be connected in a similar manner to the second horizontal path, from where they may be connected to various inputs. The outputs of ALU 230 may similarly be connected to the third horizontal path. The fourth horizontal path may be used to connect outputs from other LMs in other CU controllers into the matrix of crossbar switch 260, while the fifth (highest) horizontal path may be used to connect outputs from switch 150 into the matrix.

CU controller 240 may provide various control functions within CU 110, such as but not limited to configuring the crossbar switch 260 and controlling addresses for AGU 250 to address global memory. In some embodiments CU controller 240 may also route data into/out of CU 110. LM 220 may provide memory space to work with in the CU 110. LM 220 may store data received from outside CU 110, data to be transmitted out of CU 110, and intermediate data created within CU 110. FD 170 is shown as an external device that may transfer data into/out of LM 220 from outside of CU 110. LM 220 is shown as a two-port memory so that external memory accesses won't interfere with internal memory accesses, but other techniques may be used. ALU 230 may provide arithmetic and logic functions on data from LM 220 and/or ARPLA 210, and may store the results of those functions in either/both of those devices. Register files are shown as input/output ports in devices LM 220, ARPLA 210, and ALU 230 for communication with crossbar switch 260, but other techniques may be used. A bidirectional interface to crossbar switch 150 (see FIG. 1) is shown, permitting communication between CU 110 and crossbar switch 150.

Each ARPLA 210 may contain multiple lookup tables (LUT) 212. These LUTs may be programmed to define the operations performed by ARPLA 210. In the illustrated embodiment these LUTs may be programmed by FD controller 170, but other embodiments may permit programming the LUTs through other means.

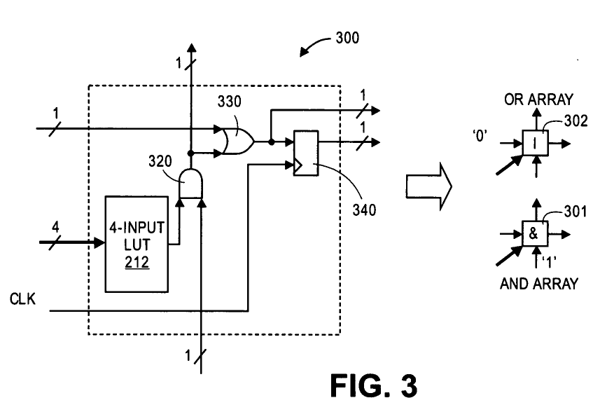

A more detailed description of some embodiments of an ARPLA 210 is provided by FIGS. 3-5 and the associated text, the description beginning with a lower level basic cell and progressively expanding to larger logic units.

FIG. 3 shows a block diagram of a basic cell, according to an embodiment of the invention. In the illustrated embodiment, basic cell 300 contains an LUT 212, a programmable lookup table that may perform selected logic operations depending on how it is programmed. For example, LUT 212 may be programmed to perform operations such as, but not limited to, simple binary logic, mathematical operations, value selection, etc. Techniques and circuits for programming a lookup table are known, and are not described herein to avoid obscuring an understanding of the embodiments of the invention. The embodiment shown has a 4-input, 1-output LUT, but other sizes may be used. The embodiment shown also includes, in the basic cell 300, an AND gate 320 and an OR gate 330, coupled to the output of LUT 212. The input shown at the bottom of basic cell 300 may be used to selectively pass or disable the output from LUT 212, with the output of the AND gate 320 appearing at the top of the basic cell. Similarly, the input at the left of basic cell 300 may be used to selectively pass or disable the output of OR gate 330, with the output of the OR gate appearing at the right of the basic cell. Clocked latch 340 may be used as an alternate output to retain an output from the OR gate 340 after other inputs to the basic cell 300 have changed.

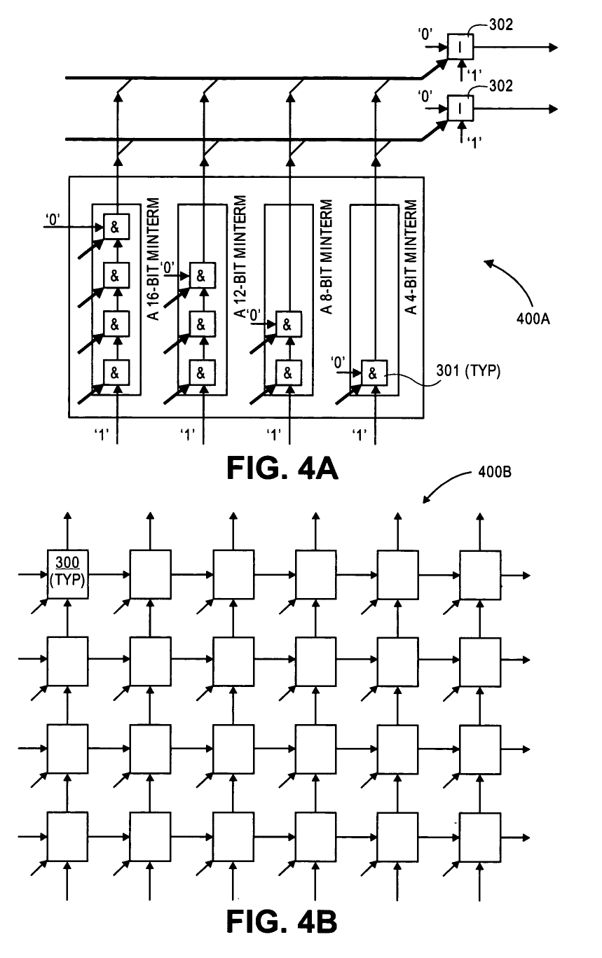

Two possible configurations of basic cell 300 are indicated by AND array 301 and OR array 302. A logic ‘1’ at the bottom input permits the output of LUT 212 to appear at the top output of basic cell 300 (this configuration is represented by AND array 301), while a logic ‘0’ at the left input permits the output of LUT 212 to appear at the right output of basic cell 300 (this configuration is represented by OR array 302), either in its normal or its latched state. In the drawing convention used in FIGS. 3 and 4, the left and bottom inputs, as well as the right and top outputs, of arrays 301, 302 correspond to those equivalent inputs/outputs of basic cell 300, while the diagonal input to each of arrays 301, 302 correspond to the multi-bit LUT inputs of basic cell 300. The illustrated embodiment shows a four-bit LUT input, single-bit left and bottom inputs, a single-bit top output, and a single-bit right output that may be latched or not latched, but other embodiments may have other configurations. Other embodiments may also differ from the simple internal logic arrangement shown in basic cell 300.

FIG. 4A shows a block diagram of a programmable logic array (PLA) containing basic cells, according to an embodiment of the invention. In the illustrated embodiment, PLA 400A is configured to contain multiple AND arrays 301 (although ten AND arrays are shown, only one is labeled 301 to avoid cluttering up the drawing with labels), and multiple OR arrays 302. The specific configuration illustrated is described here, although other configurations are possible. As shown, the four AND arrays of the left column, each with a four-input LUT, are connected to form a 16-input, 1-output operation, with each AND array producing an output that is ANDed with the outputs of the other 3 AND arrays to produce an output at the top of the column. The next column forms a 12-input, 1-output operation using 3 AND arrays. The next two columns are similar, but with 8-inputs and 4-inputs, respectively. Each column is referred to as a minterm, containing a combination of lookup tables and logic gates. The outputs from each of the four minterms is then fed into the LUTs of each of the two OR arrays 302.

Although the illustrated embodiment contains a specified number of basic cells coupled together in a specified manner (i.e., AND arrays coupled serially, with their final outputs coupled to an OR array in parallel, other embodiments may contain a different number of basic cells, programmed to place AND arrays and OR arrays in different places with respect to each other, and coupled together in a different manner. Further, additional basic cells may be included but programmed to be transparent (for example, each of the columns in FIG. 4 might have four basic cells, with each cell not shown being programmed to pass through the output of the cell beneath it without change). Still further, the various LUTs in the basic cells may each be programmed in a different way to perform various operations, allowing a PLA to be programmed in many different ways to perform many different operations.

FIG. 4B shows a block diagram of a PLA containing basic cells, according to another embodiment of the invention. In PLA 400B, basic cells 300 (the one labeled ‘300’ may be considered typical of the other 23 shown) are connected in an x-y matrix, with the vertical connections providing AND connectivity and the horizontal connections providing OR connectivity. The illustrated embodiment shows the basic cells 300 arranged in a 4×6 matrix, but other embodiments may create matrices of other sizes. As indicated in FIG. 3, in some embodiments the horizontal outputs may be latched or not. Other embodiments may utilize connections between basic cells that are not illustrated.

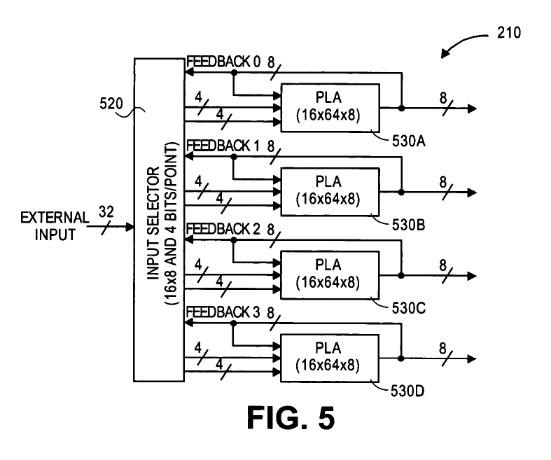

FIG. 5 shows a block diagram of an ARPLA, according to an embodiment of the invention. In the illustrated embodiment, ARPLA 210 may comprise multiple PLAs 530 and an input selector 520 to provide inputs to the PLAs 530. The particular embodiment shown has four PLAs, with each PLA having 16 input bits, 8 output bits, and 64 minterms, with the 8 output bits being fed back into 8 of the 16 input bits, although other embodiments may have other quantities of any or all of those elements. The particular embodiment shown further has an input selector with 32 external input bits, 32 feedback input bits, and 32 output bits, with the various bits being switched in groups of 4 bits each, although other embodiments may have other quantities of any or all of those elements. Both the input bits to the ARPLA (i.e., the external input bits to the input selector 520) and the output bits from the ARPLA (i.e., the outputs from the various PLAs) may be connected to the crossbar switch 260 as shown in FIG. 2. Although the PLAs 530 of the ARPLA 210 are shown connected in a particular arrangement, they may be connected in other arrangements for specific applications, such as but not limited to: 1) a serial arrangement, 2) a bus, 3) a mesh, 4) etc.

By changing the contents of the LUTs and the control logic affecting various portions of the ARPLA, the ARPLA may be configured to operate in at least two different modes: 1) logic realization, and 2) pattern recognition and/or generation. For logic realization, LUT's may be used, for example, to make state machines and/or perform Galois field arithmetic. For pattern recognition and/or generation, LUTs may, for example, be turned into 16-bit shift registers. In a particular embodiment, two control bits to the ARPLA may be used to select up to four different operational modes:

00—Logic realization (e.g., state machines, Galois field arithmetic, address generators)

01—No operation or not used.

10—Shift Registers (e.g., linear finite shift registers)

11—Counter (e.g., timers)

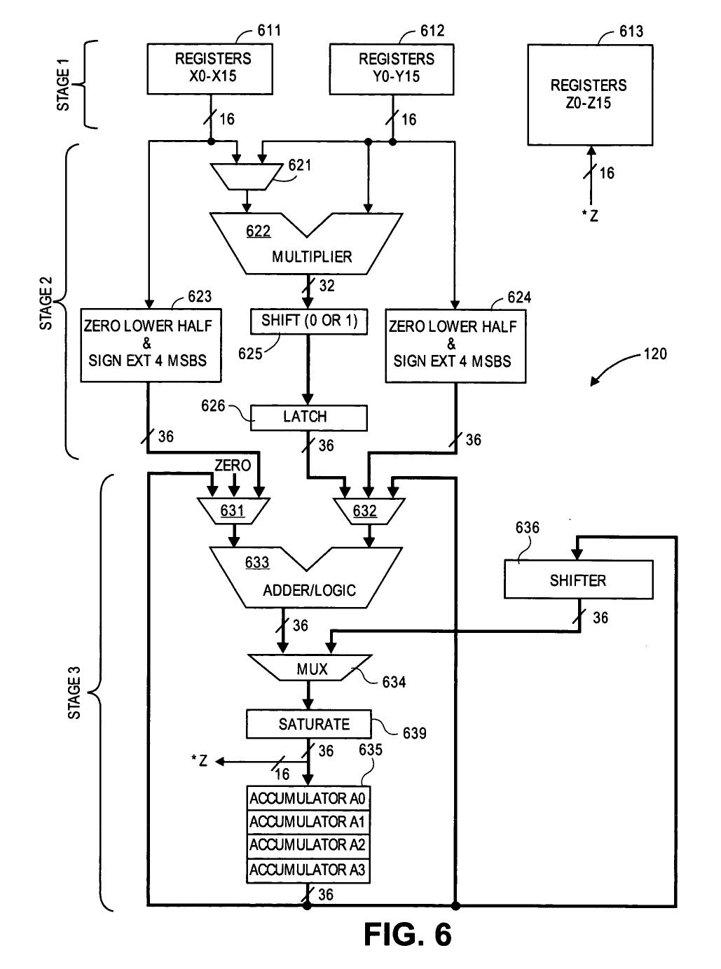

FIG. 6 shows a block diagram of a special function unit (SU) to perform calculations, according to an embodiment of the invention. In the illustrated embodiment, SU 120 may comprise a multiply and add (MADD) unit, with a multiplier circuit followed by an adder/accumulator circuit. Although an SU with a particular configuration of logic elements is shown and described, other embodiments may use SUs with other configurations of logic.

The illustrated SU 120 contains three stages. Stage 1 contains the input and output registers for the SU, stage 2 contains a multiplier circuit with square, shift, and bypass logic, while stage 3 contains adder and shift logic, with accumulators to hold intermediate results. In stage 1, source registers 611 (X0-X15) and 612 (Y0-Y15) provide initial inputs to the SU, and destination registers 613 (Z0-Z15) provide the results of the SU calculations. The registers are all shown as 16 bit registers, with 16 registers in each group, but other sizes and quantities of registers may also be used.

In stage 2, multiplexer 621 permits multiplier 622 to either square a number from source registers 612, or to multiply a number from source registers 611 by a number from source registers 612. The results of that calculation may be shifted or not shifted by shifter 625, and the results latched in latch 626. Some embodiments may use fall-through logic rather than clocked logic in stage 2, so that the multiplication and shift operations may be performed in a single clock cycle. In the event that no multiplication is needed, bypass logic 623 and 624 may bypass the multiplication and shift logic. The bypass logic may also increase the width of the received numbers, such as by adding zero bits and/or by adding sign extensions, so that the results will be compatible in size and format with the output of latch 626.

In stage 3, multiplexer 632 may permit one input of adder 633 to selectively be the output of latch 626, the output of bypass logic 624, or an output from accumulators 635. Multiplexer 631 may permit the other input of adder 633 to selectively be either the output of bypass logic 623, an output of accumulators 635, or all zero's to effectively prevent an add operation. The output of the adder 633 may be stored in accumulators 635. Multiplexer 634 and shifter 636 may permit an output from accumulators 635 to be shifted and re-stored in accumulators 635. Saturate logic 639 may permit the output of multiplexer 634 to undergo a saturation operation before being stored in the accumulators 635. As can be seen, the selective use of the logic in SU 120 may provide iterative calculations of various types, involving multiplication, addition, and shifting. When a series of iterative calculations is complete, the results, as seen at the output of multiplexer 634, may be stored in registers 613, from where these results may be available to other logic such as global memory 160 and/or other devices through crossbar switch 150 (FIG. 1). The illustrated embodiment shows specific numbers of bits (such as 16, 32, or 36) in the paths between various logic elements, but other quantities of bits may also be used.

The SU's 120 may be controlled to perform various operations. Table 1 shows one embodiment in which various control bits are used to control SU operation. Other embodiments, using other quantities of control bits and/or using them for other specific purposes, are also possible.

TABLE 1

| Control | # bits | Description |
|---|---|---|
| Select X register input | 4 | X0-X15 |
| Select Y register input | 4 | Y0-Y15 |
| Select Z register output | 4 | Z0-Z15 |
| Square | 1 | Yn*Yn |
| Shift | 1 | Left shift by 1 |
| Input select of operand X | 2 | Input, zero, previous |
| Input select of operand Y | 2 | Input, multiplier, previous |
| ALU functions | 2 | Add, Subtract, Round, Absolute |
| Mux | 1 | Shifter or ALU |
| Saturate | 1 | Saturate or not |
| Read address of accum | 2 | A0, A1, A2, A3 |
| Write address of accum | 2 | A0, A1, A2, A3 |
| Shifter | 4 | Left shift 0-7, right shift 1-8 |

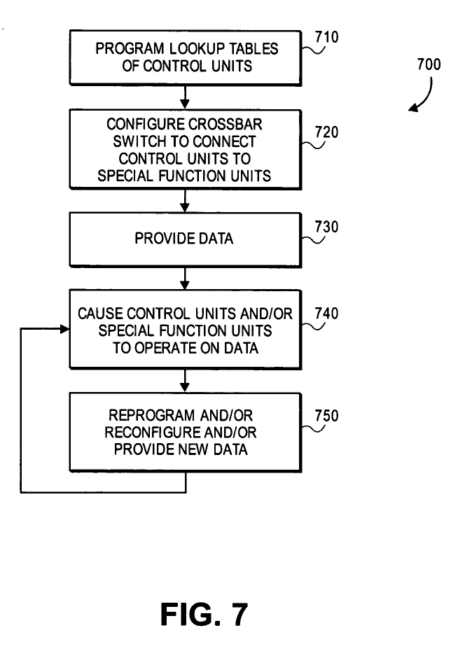

FIG. 7 shows a flow diagram of a method of configuring and operating a GPMCA, according to an embodiment of the invention. In flow chart 700, at 710 the lookup tables located in multiple control units may be programmed for specific operations. At 720 a crossbar switch may be configured to connect each one of specified control units to one or more particular special function units. In some configurations a single control unit may be connected to a single special function unit, the two units to operate cooperatively on a subset of data to be provided. In other configurations a single control unit may be connected to two or more special function units to operate cooperatively. For example, one control unit may be connected to two special function units so the special function units can operate on double-width data, although various embodiments of the invention are not limited in this manner.

In some embodiments the special function units may also be configured to operate in a particular manner. Once particular control units have been programmed and connected to particular special function units by configuring the switch, data may be provided at 730 to each cooperating set of control unit/special function units, and at 740 the cooperating sets may be caused to operate upon the data in the manner prescribed by the aforementioned programming and configuring. In some types of operations, the control unit may operate on data without involving any special function units, while in other operations the control unit and associated special function units may operate together. After completing operating on the data, any of several operations may follow at 750:

1) new data may be provided, or

2) one or more control units may be reprogrammed, or

3) the crossbar switch may be reconfigured to connect control units to special function

units differently, or 4) any combination of 1), 2), and/or 3).

After completing the changes at 750, the cooperating control units and special function units may again operate on data at 740, although in a possibly different manner, depending on the specific operations at 750. Alternatively, operations may also cease at 750. In the described manner, a GPMCA may be dynamically reconfigured to process different data and/or process the data in different ways, including operating on possibly different block sizes of data.

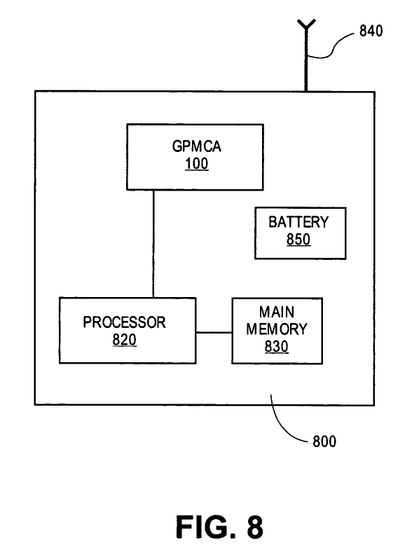

FIG. 8 shows a block diagram of a system, according to an embodiment of the invention. System 800 may be any of various devices or groups of devices, such as but not limited to: a cellular telephone, a desktop personal computer, a wireless notebook computer, a personal data assistant, an access point, etc. System 800 may include a GPMCA 100, such as described previously, and may also include a processor 820 and a main memory 830 from which the processor 820 may get instructions and data. In some embodiments the main memory may comprise a volatile memory such as, but not limited to, a dynamic random access memory (DRAM) or a static random access memory (SRAM). In other embodiments the main memory may comprise a non-volatile memory such as, but not limited to, flash memory or phase-change memory. In some embodiments system 800 may also comprise an antenna 840 to transmit and receive wireless signals, and/or a battery 850 to power system 800 without the need to be plugged into a stationary power source.

Referencing FIG. 1 again, the GPMCA 100 may be used in various ways. In some embodiments, it may be used in a wireless device to handle a general set of operations that follow the front end signal processing (e.g., filtering, etc.) and perform symbol decoding/encoding as well as post-front end bit level operations like descrambling, cyclic redundancy check (CRC), etc. In some embodiments the GPMCA may carry out multiple operations concurrently if configured to do so. The GPMCA 100 may operate on packets or other data stream segments in various ways, such as but not limited to:

Receive: channel correction, residual frequency and sample offset correction, QAM demapping, soft metrics generation, deinterleaving, descrambling, CRC, etc.

Transmit: scrambling, convolutional encoding and puncturing, interleaving, and OFDM modulation, etc.

The GPMCA 100 may also handle Lower Media Access Control (LMAC) or datalink layer operations, such as packet address filtering and Network Allocation Vector (NAV) decoding and updates. Control of operations such as acknowledge (ACK) and clear-to-send/ready-to-send (CTS/RTS) protocols may also be handled since they may be time intensive operations requiring fast processing. In addition, the GPMCA 100 may be configured to operate as a state machine to work in conjunction with other state machines. In some embodiments the GPMCA 100 may handle bit operations, Galois field operations, fixed-point arithmetic operations, and/or table lookup operations, for example, in frequency domain processing of baseband signal and LMAC processing.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. An apparatus, comprising:
a plurality of control units;
a plurality of multiply and add units; and
switch circuitry to couple any one of the control units to any one or more of the multiply and add units to enable said one of the control units to operate cooperatively with the coupled one or more multiply and add units;
wherein each of the control units is programmable to enable multiple types of operations.

2. The apparatus of claim 1, wherein the switch circuitry comprises a crossbar switch.

3. The apparatus of claim 1, wherein at least one of the control units comprises an array of programmable logic arrays (ARPLA).

4. The apparatus of claim 3, where said at least one of the control units further comprises a memory, an arithmetic logic unit, and circuitry to operatively couple the ARPLA, memory, and arithmetic logic unit to one another.

5. The apparatus of claim 3, wherein the apparatus is configurable to perform multiple operations selected from a list consisting of: bit operations, Galois field operations, fixed-point arithmetic operations, and table lookup operations.

6. The apparatus of claim 3, wherein the ARPLA comprises multiple programmable lookup tables.

7. The apparatus of claim 1, wherein each multiply and add unit is adapted to be placed in a low-power mode if not being controlled by any of the control units.

8. A system, comprising:
a processor;
an apparatus coupled to the pprocessor and comprising
a plurality of programmable control units;
a plurality of multiply and add units; and
switch circuitry to couple any one of the control units to any one or more of the multiply and add units to enable said one of the control units to operate cooperatively with the connected one or more multiply and add units.

9. The system of claim 8, wherein the system further comprises a battery coupled to the processor.

10. The system of claim 8, where the system further comprises an antenna coupled to the processor.

11. The system of claim 8, wherein at least one of the control units comprises an an array of programmable logic arrays.

12. A method, comprising:
programming multiple control units by transferring data into multiple lookup tables within each of the multiple control units;
configuring a switch circuit to operably couple each of the multiple control units to at least one of multiple special function units;
providing a first set of data; and
causing the control units and the connected special function units to act upon the first set data to produce a second set of data.

13. The method of claim 12, further comprising:
reprogramming the multiple control units; and
repeating said causing.

14. The method of claim 12, further comprising:
reconfiguring the switch circuit; and
repeating said causing.

15. The method of claim 12, further comprising:
providing a third set of data; and
causing the control units and the special function units to act upon the third set of data to produce a fourth set of data.

16. An article comprising
a machine-readable medium that provides instructions, which when executed by a processing platform, cause said processing platform to perform operations comprising:
programming multiple control units by transferring data into multiple lookup tables within each of the multiple control units;
configuring a switch circuit to operably couple each of the multiple control units to at least one of multiple special function units;
providing a first set of data; and
causing the control units and the connected special function units to act upon the first set data to produce a second set of data.

17. The article of claim 16, the operations further comprising:
reprogramming the multiple control units; and
repeating said causing.

18. The article of claim 16, the operations further comprising:
reconfiguring the switch circuit; and
repeating said causing.

19. The article of claim 16, the operations further comprising:
providing a third set of data; and
causing the control units and the special function units to act upon the third set of data to produce a fourth set of data.
